(19) United States
(12) Patent Application Publication
(10) Pub. No.: US 2007/0198973 A1
(43) Pub. Date: Aug. 23, 2007

(54) Computer-implemented method, system, and program product for deployment time optimization of a distributed application

(75) Inventors: Jong-Deok Choi, Mount Kisco, NY (US); Manish Gupta, Yorktown Heights, NY (US); Parviz Kermani, South Salem, NY (US); Kang-Won Lee, Nanuet, NY (US); Kyung Dong Ryu, New City, NY (US); Dinesh C. Verma, Mount Kisco, NY (US); Peng Wu, Fairport, NY (US)

Correspondence Address: HOFFMAN, WARNICK & D'ALESSANDRO LLC, 75 State Street, 14th Floor, ALBANY, NY, 12207, US

(73) Assignee: International Business Machines Corporation, Armonk, NY (US)

(21) Appl. No.: 11/345,748

(22) Filed: Feb. 2, 2006

(51) Int. Cl. G06F 9/45

(52) U.S. Cl. 717/151

(57) ABSTRACT

A computer-implemented method, system, and program product for optimizing a distributed (software) application are provided. Specifically, a configuration of a target computing environment, in which the distributed application is deployed, is discovered upon deployment of the distributed application. Thereafter, based on a set of rules and the discovered configuration, one or more optimization techniques are applied to optimize the distributed application. In a typical embodiment, the set of rules can be embedded in the distributed application, or they can be accessed from an external source such as a repository. Regardless, the optimization techniques applied can include at least one of the following: (1) identification and replacement of an underperforming component of the distributed application with a new component; (2) generation of interface layers (to allow selection of optimal bindings) between distributed objects of the distributed application; and/or (3) execution of code transformation of the distributed application using program analysis techniques.

### BACKGROUND OF THE INVENTION

1. Field of the Invention

In general, the present invention relates to application optimization. Specifically, the present invention relates to a computer-implemented method, system, and program product for optimizing a distributed (software) application using information that is available at the deployment time of the application.

2. Related Art

The performance of a software system heavily depends on the design and implementation of the system. To this extent, substantial efforts have been put into inventing development time optimization techniques. Unfortunately, such techniques are fundamentally limited since at development time, crucial information about the target environment (where the software will be deployed) is not available. Since software developers cannot assume the specifics of the actual operational setting of the software, the developers typically employ generic application programming interfaces (APIs) and the most general “bindings” between software components.

Similar problems exist for distributed applications, which typically involve interoperation among multiple components that may be running on different platforms. In order to handle such issues the distributed computing community has developed layers of middleware abstractions. The abstractions include standardized network socket interfaces, remote procedure call and remote method invocation models, common object request broker architecture (CORBA), and more recently service-oriented architecture (SOA) based on Web Services. In particular, CORBA and Web Services aim to provide communication amongst distributed objects regardless of their platform and language differences.

Such middleware layers provide nice abstraction to software developers. However, naive adoption of such technologies can adversely impact the performance of distributed applications. For example, programmers may develop an application on top of a heavy-weight Web service binding, based on SOAP/XML technology, even when a more light-weight invocation mechanism such as Java RMI is sufficient. In another example, a database application written against the standard JDBC APIs may not exploit vendor-proprietary features offered by the database system in the actual operating environment. In other words, the performance of a distributed application may become crippled because the developers have opted to use generic middleware layers, which are convenient to program upon, without considering its performance implication. On the other hand, in many cases, this problem cannot be easily avoided since little is known about the target operation environment during the development time of software.

Current optimization techniques focus on individual components in an isolated manner. For example, techniques exist that attempt to improve the performance of communication layers between distributed components. Such techniques include high-performance XML parsing, and efficient implementation of protocol layers (e.g., SOAP). Other techniques include data caching at the network layer (e.g., SOAP result caching, and DB query caching), availing of multiple ways to communicate between the components (e.g., WSIF), and manually selecting the most appropriate binding during code development and/or inspection time.

However, these existing optimization techniques have drawbacks. First they do not utilize the information about the target environment where the software will be deployed and configured. Second, in many cases, those optimization techniques are applied independently to improve the performance of a specific function without considering the interactions between the components. Third, although such techniques may improve the performance of individual components, there are inherent overheads of going through multiple layers of abstraction. Finally, manual optimization techniques do not scale and cannot be applied in various different domains.

In view of the foregoing, there exists a need for a solution that addresses the above-referenced deficiencies.

### SUMMARY OF THE INVENTION

In general, the present invention provides a computer-implemented method, system, and program product for optimizing a distributed (software) application. Specifically, under the present invention, a configuration of a target computing environment, in which the distributed application is deployed, is discovered upon deployment of the distributed application. Thereafter, based on a set of rules and the discovered configuration, one or more optimization techniques are applied to optimize the distributed application. In a typical embodiment, the set of rules can be embedded in the distributed application (e.g., implicit rules), or they can be accessed from an external source such as a repository (e.g., explicit rules). Regardless, the optimization techniques applied can include one or more of the following: (1) identification and replacement of an underperforming component of the distributed application with a new component; (2) generation of interface layers (to allow selection of optimal bindings) between distributed objects of the distributed application; and/or (3) execution of code transformation of the distributed application using program analysis techniques.

A first aspect of the present invention provides a computer-implemented method for optimizing a distributed application, comprising: discovering a configuration of a target computing environment upon deployment of the distributed application; providing a set of rules; and applying at least one optimization technique based on the set of rules to optimize the distributed application.

A second aspect of the present invention provides a system for optimizing a distributed application, comprising: a configuration system for discovering a configuration of a target computing environment upon deployment of the distributed application; and a system for applying at least one optimization technique based on a set of rules to optimize the distributed application, the at least one optimization technique being selected from the group consisting of replacing an underperforming component of the distributed application, generating multiple bindings between distributed objects of the distributed application, and performing a code-level transformation of the distributed application.

A third aspect of the present invention provides a program product stored on a computer-useable medium for optimizing a distributed application, the computer useable medium comprising program code for causing a computer system to perform the following steps: discovering a configuration of a target computing environment upon deployment of the distributed application; and applying at least one optimization technique based on a set of rules to optimize the distributed application, the at least one optimization technique being selected from the group consisting of replacing an underperforming component of the distributed application, generating multiple bindings between distributed objects of the distributed application, and performing a code-level transformation of the distributed application.

A fourth aspect of the present invention provides a method for deploying an application for optimizing a distributed application, comprising: providing a computer infrastructure being operable to: discovering a configuration of a target computing environment upon deployment of the distributed application; and applying at least one optimization technique based on a set of rules to optimize the distributed application, the at least one optimization technique being selected from the group consisting of replacing an underperforming component of the distributed application, generating multiple bindings between distributed objects of the distributed application, and performing a code-level transformation of the distributed application.

A fifth aspect of the present invention provides computer software embodied in a propagated signal for optimizing a distributed application, the computer useable medium comprising instructions for causing a computer system to perform the following steps: discovering a configuration of a target computing environment upon deployment of the distributed application; and applying at least one optimization technique based on a set of rules to optimize the distributed application, the at least one optimization technique being selected from the group consisting of replacing an underperforming component of the distributed application, generating multiple bindings between distributed objects of the distributed application, and performing a code-level transformation of the distributed application.

### BRIEF DESCRIPTION OF THE DRAWINGS

These and other features of this invention will be more readily understood from the following detailed description of the various aspects of the invention taken in conjunction with the accompanying drawing that depicts various embodiments of the invention, in which:

FIG. 1 depicts a flow diagram according to the present invention

FIG. 2 depicts a system for optimizing a distributed application according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

For convenience purposes the Detailed Description of the Invention will have the following sections:
I. General Description
II. Typical Embodiment
III. Computerized Implementation
   I. General Description

As indicated above, the present invention provides a computer-implemented method, system, and program product for optimizing a distributed (software) application. One aspect of the present invention is to provide deployment time optimization (DTO) that removes redundant processing, replaces slow components with faster alternatives, and adds caching and other modules transparently to improve application performance. This typically occurs during the installation of the deployment process of an application using the configuration information about the target operation environment.

The approach taken by deployment time optimization can be considered macro level compilation since it tries to improve the performance by composing the right components at module level. By “components,” we mean libraries, database drivers, network protocols, middleware components, and other files that are linked with the applications. Since DTO typically works at a component level, the granularity of each component can affect the effectiveness of the optimization. Also, it is helpful if the application itself is to some extent componentized. For example, if an application encapsulates the binding logic and contains only one type of binding, then it cannot readily benefit from the target environment supporting multiple types of binding. In such cases, additional steps can be performed to transform the original application into a componentized form. This can be facilitated by code transformation.

Under the present invention, a configuration of a target computing environment, in which the distributed application is deployed, is discovered upon deployment of the distributed application. Thereafter, based on a set of rules and the discovered configuration, one or more optimization techniques are applied to optimize the distributed application. In a typical embodiment, the set of rules can be embedded in the distributed application as part of the application (implicit), or they can be accessed from an external source such as a repository (explicit). Regardless, the optimization techniques applied can include one or more of the following: (1) identification and replacement of an underperforming component of the distributed application with a new component; (2) generation of interface layers (to allow selection of optimal bindings) between distributed objects of the distributed application; and/or (3) execution of code transformation of the distributed application using program analysis techniques. It should be understood that any of these optimization techniques may implement different features than the others, but in a given configuration, provide the same effect.

II. Typical Embodiment

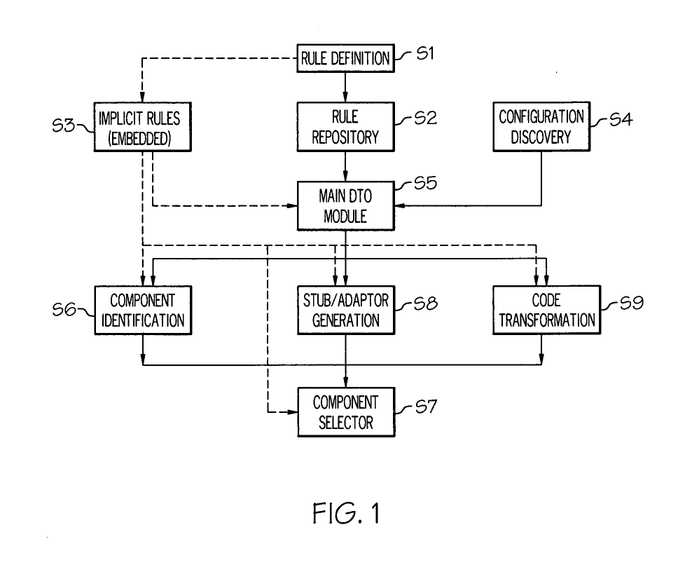

A typical embodiment of the present invention will be described in conjunction with the flow diagram of FIG. 1. In the following, each step of deployment time optimization is described using this figure.

II.A. Rule Definition

As indicated above, the present invention utilizes a set (e.g., one or more) of rules to transform a distributed software system (hereinafter “distributed application”) during the deployment, initialization, installation, or configuration (Step S1). In general, a rule is defined in the (if condition then action) format, which is interpreted as “if condition is satisfied (or true) then apply the technique specified in the action field. Under the present invention, the condition field may include of target environment parameters and the action field may specify particular techniques to use. For example, a rule may state “if service location is local then use RMI binding (instead of SOAP binding),” or “if the application is of type XYZ then do not perform transformation since it is not safe.” Such rules can be defined explicitly and stored in a policy repository (Step S2). Alternatively, often the rules may be encoded and implemented in each of the component that needs to take such actions. In the latter, we say the rule is implicit (Step S3). It is noted that the above if-then notation is for illustration only, and does not confine the kind of rule-based system that can be used; a rule can have any format (e.g. event-action format or subject-action-target format).

II.B Configuration Discovery

The next step (Step S4) in deployment time optimization (DTO), is to discover the configuration of the target environment where the distributed application is deployed. In the binding selection scenario, the role of a configuration discovery module is first to identify the types of bindings that the service support. This information can be found from the extended WSDL published by the service. It then determines the relative location of the service and the client—for example, they may be located in the same JVM, in the same physical machine, on the same subnet, or connected via wide area network. In addition, it also needs to determine whether there is a firewall between the client and the server. After collecting all the configuration information, it passes the information to the smart stub, which will select an appropriate (network) binding. This process is called configuration discovery and component identification, and it provides a critical piece of information for subsequent decision making process.

For example, if the client and server are deployed together in the same EAR file, then they can communicate via EJB local interface, which is equivalent to making a native Java call. Also if they will be executed in the same class loader, they can use EJB local binding. On the other hand, if they are deployed on the same JVM but not in the same EAR, then they can communicate via EJB remote interface, with local RMI, which is known to be more efficient than remote RMI. If they are on different machines, but there is no firewall in between then they can use EJB remote interface with remote RMI. Finally, if a firewall exists between the client and the service, then they must communicate through SOAP over HTTP.

The configuration discovery module may employ various techniques to detect the relative location and the existence of a firewall. First, it knows the case when a client and a service are contained in the same EAR file since in this case the client is deployed with the service. It can also detect whether they are in the same JVM or not by using javax.rmi.CORBA.Util.isLocal method. Whether a client and a service are on the same subnet can be determined from the subnet mask. The existence of a firewall can be determined by sending a few probe messages to the RMI port.

First, the DTO module may identify the shortcomings of a software component (i.e., an under-performing component) in step S6, and then replace the under-performing component with a new adequately performing component in step S7. For example, although a default JDBC driver does not support advanced features such as connection-pooling, there may be some other JDBC driver that supports connection pooling. In that case, the default JDBC driver can be replaced by a component with more efficient implementation. In a typical embodiment, the DTO module will replace a software component with some other component only when both of them are functionally equivalent so that the replacements are transparent to the application. The replacement rules may be used in step S7 to dictate when and how to replace the modules.

II.C Component Identification and Selection

Once the configuration of the deployed environment(s) have been determined, the main DTO module of Step S5 can apply one or more optimization techniques the structure and organization of the distributed application based on the rules defined earlier. It is noted that if the set of rules are stored in a repository, then the DTO module should retrieve only the rules that are applicable in the particular domain. In any event, based on the configuration information and the set of rules, one or more of the following optimization techniques will be applied to optimize the deployment of software: (1) component identification, (2) stub/adapter generation, and (3) code transformation.

When deploying a distributed application, it is important to identify all the components that can be used for configuration and their features and drawbacks. The role of a component identification module is to identify the software component in the target environment. For example, there can be a JDBC driver that provides connection-pooling and data set abstraction but is fast, while some other JDBC driver provides data set abstraction, distributed transaction support, and result set but is slow. Identifying these components and their features and performance characteristics can help to match the optimum driver with the application to be deployed. For example, if the application makes a heavy use of connection pooling and does not require distributed transaction support, then it is better to use the former driver. But if the application requires distributed transaction support, it must select the latter. In another example, we may have a choice between a type 2 JDBC driver, which consists of Java component and native code, may be efficient in terms of performance but not portable; and a type 4 JDBC driver, which is portable but slow. If an application is being deployed to a specific target environment, then selecting a type 2 JDBC driver may be a better option because it is faster.

It is important to note that the DTO module may choose between software components, or select one software component with some other component only when both of them are functionally equivalent. It should also be noted that such replacements should be transparent to the application. The replacement rules may be used by the selector module when and how to replace the modules. It is also important to note that the alternatives considered by selector module may have less or different features. The only constraint is that they are equivalent in a given operation environment (as identified in the JDBC driver example). One important special case of replacement is removal of a component. In other words, when a component does not provide much added function in a target environment, then that layer may be removed. For example, if the link and network layers provide adequate level of error control, then the transport layer may do with out error control function in order to achieve improved performance. The proposed inventive method enables such optimizations.

II.D Stub/Adapter Generation

Another optimization technique that can be applied under the present invention is shown in Step S8. Under this technique, multiple bindings (e.g., stubs/adapters) are generated between distributed objects of the distributed application. The proposed invention can be provided as an extended software development environment, such as Eclipse or Rational Application Developer, with an extension by specialized plug-ins to implement deployment optimization functions. Alternatively, such features can be provided as command line tools similar to RMIC (RMI stub compiler). Using such a programming environment, developers are supported to automatically generate stubs, containers, or interface layers so that their code can be easily restructured during deployment. For example, to enable intelligent binding selection, a plug-in, called a stub generator can be developed. The stub generator automatically creates a client-side proxy called a smart stub based on the WSDL file from the service. Essentially a smart stub hides the different invocation mechanisms between various types of bindings from the application developer.

A smart stub provides a simple unified interface for remote object creation and invocation to the application layer. Underneath it, however, it can contain several stubs for multiple bindings so that it can talk to a remote object via one of them. During the deployment of the application, the installation module calls the configuration discovery module to collect the configuration information and provides that information to the smart stub. Based on this information, the smart stub makes a decision as to which binding to create. Since it will instantiate only one of the bindings for all its communication, the smart stub does not incur any extra overhead when compared with native SOAP or RMI stub.

Using the smart stub interface, developers can write an application as if they were writing a standard RMI or SOAP application. The above code sample illustrates an example of creating and accessing a remote object via the smart stub. In this example, RemoteObjectFooProxy is a proxy that has been auto-generated by the stub generator using the WSDL file of the RemoteObjectFoo. Creating a handle for that remote object is as simple as just calling the constructor of the proxy. Once the handle is created, then it can be used in the same manner as a local instance.

II.E Code Transformation

When a developer writes an application using the inventive development environment, he or she can create a smart stub or other interface layers for the application so that later stages of deployment time optimization can be facilitated. However, when an application that has been created is deployed outside the inventive framework, it may not be in a shape that can be readily restructured or reconfigured by the installation module. For example, if an application has only a SOAP binding, then the inventive installer cannot change it to other types of binding even if it knows that SOAP is not the best option.

Code transformation technologies are applied under the present invention in such cases to generate codes that are easier to reconfigure during the deployment of applications. In the binding selection example, a code transformer will generate a corresponding smart stub for the client module by transforming the existing stub code. The code transformer of the present invention is based on a set of compiler technologies such as program slicing using forward and backward chain identification, code pattern matching, and dead code elimination. Using these program analysis techniques, it will identify the code block to be removed and insert new code block to transform the existing client stub into a smart stub. In particular, the following techniques can be applied to identify the SOAP call and replace the code block with an equivalent RMI call or a local Java call. In the following, the steps to be taken for replacing a SOAP call with a local Java call are repsented.
1. First, the “call.invoke” method is identified by employing type analysis. At this point we can obtain the fully qualified type of the remote object can be obtained.
2. Then, data flow analysis and program slicing is used to follow explicit def chain. This may require inter-procedural analysis and pointer analysis.
3. The implicit def. chain is further followed by using the semantic knowledge about the SOAP call. This requires understanding the syntax and the semantics of SOAP-related classes and their methods.
4. Once the SOAP call blocks are identified, an equivalent local Java call using the information about the remote object discovered in step 1 is constructed. This will ensure that the semantics of the original SOAP call do not change. The call.invoke with the local call is replaced.
5. Finally, the dead code related to the SOAP call is eliminated. This can be done by removing the dead code identified from explicit and implicit def chains. The SOAP call exception handling part that follows the use chain is also improved. This can be done by employing a pattern match technology.
   This technique can be used since in most cases the stub codes have fixed pattern and frequently generated by machines, which makes the program analysis step easy. Thus, one optimization technique can involve the selection of a most appropriate binding between distributed software components.

It should be understood that a selected optimization technique may implement more or less features than the others, but in a given configuration, provide the same effect.

III. Computerized Implementation

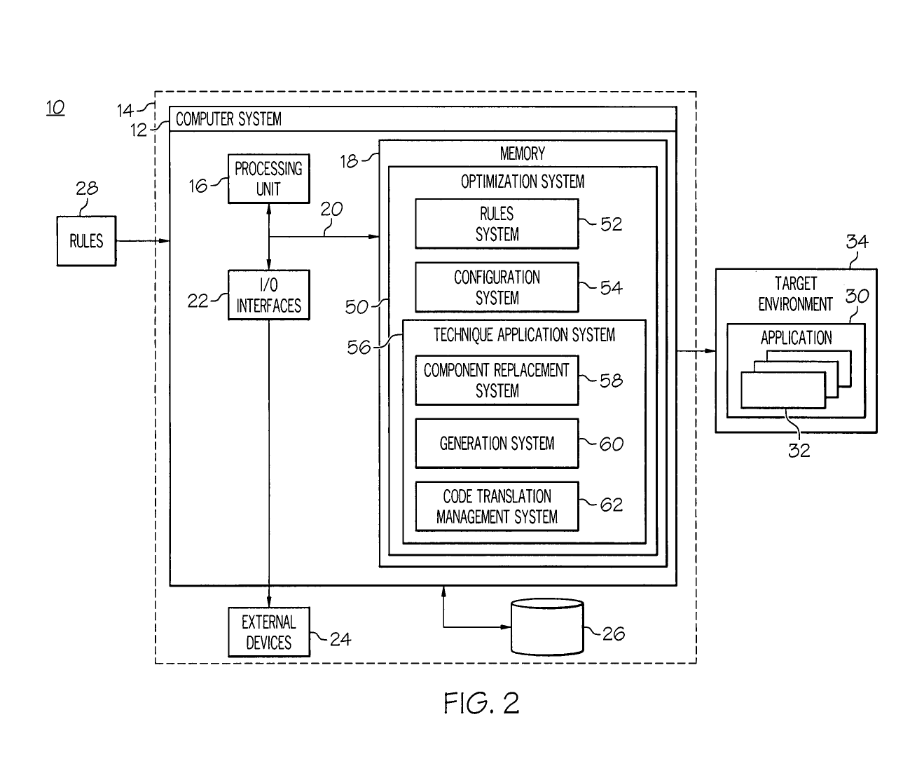

Referring now to FIG. 2, a more specific computerized implementation 10 of the present invention is shown. As depicted, implementation 10 includes a computer system 12 deployed within a computer infrastructure 14. It should be understood that computer system 12 is intended to represent any type capable of carrying optimization of distributed application 30 in accordance with the present invention. In any event, application 30 is typically a distributed software system (i.e., implemented in a network-based target environment 34), of which computer system 12 and/or infrastructure 14 may or may not be a direct part. Such a network could be the Internet, a wide area network (WAN), a local area network (LAN), a virtual private network (VPN), etc. that utilizes any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, some or all of the components of implementation 10 (e.g., those within infrastructure 14) could be deployed, managed, serviced, etc. by a service provider who offers to optimize a distributed application for customers.

As shown, computer system 14 includes a processing unit 16, a memory 18, a bus 20, and input/output (I/O) interfaces 22. Further, computer system 12 is shown in communication with external 1/0 devices/resources 24 and storage system 26. In general, processing unit 16 executes computer program code, such as optimization system 50, which is stored in memory 18 and/or storage system 26. While executing computer program code, processing unit 16 can read and/or write data to/from memory 18, storage system 26, and/or I/O interfaces 22. Bus 20 provides a communication link between each of the components in computer system 12. External devices 24 can comprise any devices (e.g., keyboard, pointing device, display, etc.) that enable a user to interact with computer system 12 and/or any devices (e.g., network card, modem, etc.) that enable computer system 12 to communicate with one or more other computing devices.

Computer system 12 is only representative of various possible computer systems that can include numerous combinations of hardware. To this extent, in other embodiments, computer system 12 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 16 may comprise a single processing unit, or be distributed across one or more processing units in one or more locations, e.g., on a client and server. Similarly, memory 18 and/or storage system 26 can comprise any combination of various types of data storage and/or transmission media that reside at one or more physical locations. Further, I/O interfaces 22 can comprise any system for exchanging information with one or more external devices 24. Still further, it is understood that one or more additional components (e.g., system software, math co-processing unit, etc.) not shown in FIG. 2 can be included in computer system 12. However, if computer system 12 comprises a handheld device or the like, it is understood that one or more external devices 24 (e.g., a display) and/or storage system(s) 26 could be contained within computer system 12, not externally as shown.

Storage system 26 can be any type of system (e.g., a repository) capable of providing storage for information under the present invention such as rules 28, source code for distributed application 30, etc. To this extent, storage system 26 could include one or more storage devices, such as a magnetic disk drive or an optical disk drive. In another embodiment, storage system 26 includes data distributed across, for example, a local area network (LAN), wide area network (WAN) or a storage area network (SAN) (not shown). Although not shown, additional components, such as cache memory, communication systems, system software, etc., may be incorporated into computer system 12. Further, it should be understood that the computer systems on which distributed application 30 is implemented will include computerized components similar to computer system 12.

Shown in memory 18 of computer system 12 is optimization system 50 (represented as DTO module in step S5 of FIG. 1), which is a software program that will provide the functions of the present invention, and which includes rules system 52, configuration system 54, and technique application system 56. As further shown, technique application system 56 includes component replacement system 58, generation system 60 and code transformation system 62.

In general, these systems represent program code that carries out the steps of the present invention as described above. Specifically, assume that distributed application 30 is the target application that will be analyzed. As indicated above, a set of rules 28 will first be defined. Under the present invention, a user/administrator (not shown) can define/provide set of rules 28 using rules system 52. This will allow set of rules 28 to be implicitly defined and embedded within distributed application 30, or explicitly defined and stored in storage system 26. Regardless, at deployment of distributed application 30, configuration system will automatically detect the configuration of the target environment 34 (i.e., in which distributed application 30 is deployed). This can include gathering various pieces of configuration information (e.g., file locations) as discussed above. Once the configuration of target environment 34 is detected, technique application system 56 will optimize distributed application 30 by applying one or more optimization techniques based on set of rules 28 (and optionally the configuration information). Specifically, based on set of rules 28, component replacement system 58 can identify one or more under-performing components 32 of distributed application 30, and replace the same with new (adequately performing) components. Moreover, based on set of rules 28, generation system 60 can generate multiple bindings between the distributed objects of distributed application 30. As described above, this can involve stub and/or adapter generation. Still yet, code transformation system 62 can use set of rules 28 to perform a code-level transformation of the source code of distributed application 30. It should be understood that a selected optimization technique may implement more or less features than the others, but in a given configuration, provide the same effect.

While shown and described herein as a method and system optimizing a distributed application, it is understood that the invention further provides various alternative embodiments. For example, in one embodiment, the invention provides a computer-readable/useable medium that includes computer program code to enable a computer infrastructure to optimize a distributed application. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 18 and/or storage system 26 (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to remotely verifying analytic integrity. In this case, the service provider can create, maintain, support, etc., a computer infrastructure, that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for optimizing a distributed application. In this case, a computer infrastructure, can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 12, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claims:

1. A computer-implemented method for optimizing a distributed application, comprising:
discovering a configuration of a target computing environment upon deployment of the distributed application;
providing a set of rules; and
applying at least one optimization technique based on the set of rules to optimize the distributed application.

2. The computer-implemented method of claim 1, the providing comprising embedding the set of rules in the distributed application.

3. The computer-implemented method of claim 1, the providing comprising retrieving the set of rules from a repository.

4. The computer-implemented method of claim 1, the discovering comprising discovering a location of a service invoked by the distributed application.

5. The computer-implemented method of claim 1, the discovering comprising discovering a version of other software used by the distributed application.

6. The computer-implemented method of claim 1, the applying comprising:
identifying a new component to replace an underperforming component of the distributed application based on the set of rules; and
replacing the underperforming component of the distributed application with the new component.

7. The computer-implemented method of claim 1, the applying comprising generating a plurality of bindings between distributed objects of the distributed application based on the set of rules.

8. The computer-implemented method of claim 1, the applying comprising performing a code-level transformation of the distributed application using on the set of rules.

9. The computer-implemented method of claim 1, the applying comprising selecting most appropriate bindings between distributed components.

10. The computer-implemented method of claim 1, the applying comprising removing at least one network protocol stacks and processing layers.

11. The computer-implemented method of claim 1, each of the at least one optimization techniques may implement different features than others of the at least one optimization technique.

12. A system for optimizing a distributed application, comprising:
a configuration system for discovering a configuration of a target computing environment upon deployment of the distributed application; and
an technique application system for applying at least one optimization technique based on a set of rules to optimize the distributed application, the at least one optimization technique being selected from the group consisting of replacing an underperforming component of the distributed application, generating multiple bindings between distributed objects of the distributed application, and performing a code-level transformation of the distributed application.

13. The system of claim 12, the set of rules being embedded in the distributed application.

14. The system of claim 12, the set of rules being stored in a repository.

15. The system of claim 12, the configuration system discovering a location of a service invoked by the distributed application.

16. The system of claim 12, the configuration system discovering a version of other software used by the distributed application.

17. A program product stored on a computer-useable medium for optimizing a distributed application, the computer useable medium comprising program code for causing a computer system to perform the following steps:
discovering a configuration of a target computing environment upon deployment of the distributed application; and
applying at least one optimization technique based on a set of rules to optimize the distributed application, the at least one optimization technique being selected from the group consisting of replacing an underperforming component of the distributed application, generating multiple bindings between distributed objects of the distributed application, and performing a code-level transformation of the distributed application.

18. The program product of claim 17, the discovering comprising discovering a location of a service invoked by the distributed application.

19. The program product of claim 17, the discovering comprising discovering a version of other software used by the distributed application.

20. A method for deploying an application for optimizing a distributed application, comprising:
providing a computer infrastructure being operable to:
discovering a configuration of a target computing environment upon deployment of the distributed application; and
applying at least one optimization technique based on a set of rules to optimize the distributed application, the at least one optimization technique being selected from the group consisting of replacing an underperforming component of the distributed application, generating multiple bindings between distributed objects of the distributed application, and performing a code-level transformation of the distributed application.
